(19) United States
(12) Patent Application Publication
(10) Pub. No.: US 2015/0127471 A1
(43) Pub. Date: May 7, 2015

(54) Social Media Marketing Auction

(71) Applicant: Michael Phillips, Seattle, WA (US)

(72) Inventor: Michael Phillips, Seattle, WA (US)

(21) Appl. No.: 14/073,242

(22) Filed: Nov. 6, 2013

(51) Int. Cl. G06Q 30/02; G06Q 50/00

(52) U.S. Cl. CPC G06Q 30/0275; G06Q 50/01
USPC 705/14.71

(57) ABSTRACT

The instant application discloses, among other things, a social media marketing auction. According to one embodiment, it may comprise an online auction site or mobile application wherein businesses can bid on offers by social media users to promote certain types of products or services. Users may also be able to utilize a filtered search feature and to sort results based on factors such as a seller's number of followers, interests, age, and geographic location, for example.

### FIELD

This disclosure relates generally to a Social Media Marketing Auction.

### BACKGROUND

Social media networks engage billions of users around the world. On many social media platforms, a user may gain followers, fans, or friends who may subscribe to that user's account to receive updates, exchange messages, or simply express interest in that user. Social networking websites and mobile applications may serve as powerful and cost-effective marketing tools for individuals, organizations, and businesses.

### SUMMARY

The following presents a simplified summary of the disclosure to provide a basic understanding to the reader. This summary is not an extensive overview of the disclosure, nor does it identify key or critical elements of the claimed subject matter, or define its scope. Its sole purpose is to present some concepts disclosed in a simplified form as a precursor to the more detailed description that is later presented.

The instant application discloses, among other things, techniques to provide for a Social Media Marketing Auction. In one embodiment, a website may host an online auction where businesses or other users may place bids on offers made by social media users to promote particular types of products or services. For example, a reality television star may offer to promote a style of designer shoes to her social media followers in a tweet, status update, podcast, or other type of publication on any social networking platform such as Twitter, Facebook, or Instagram. The company that places the highest bid by the time the auction ends may be deemed the winner and may communicate with the seller to complete the transaction. The social media user, or seller, who auctioned off the marketing service may receive payment in the amount offered by the bidder. The company the hosting the auction website may also profit from the transaction, for example, by charging the seller a percentage of the final sale price or by imposing service fees.

The Social Media Marketing Auction may also include a filtered search feature and results sorting capability so buyers and sellers may target their desired demographics in accordance with their business and marketing goals. A person skilled in the art will understand that Social Media Marketing Auction may take comprise various forms, for example, a mobile application.

Many of the attendant features may be more readily appreciated as they become better understood by reference to the following detailed description considered in connection with the attached drawings.

### BRIEF DESCRIPTION OF THE DRAWINGS

The present description may be better understood from the following detailed description read in light of the appended drawings, wherein:

FIG. 1 is a system capable of supporting Social Media Marketing Auction according to one embodiment.

FIG. 2 is a flow diagram illustrating a Social Media Marketing Auction process to create a listing according to one embodiment.

FIG. 3 is a flow diagram illustrating a Social Media Marketing Auction process to buy from a listing according to one embodiment.

FIG. 4 is a user interface layout for conducting a search according to one embodiment.

FIG. 5 is a user interface layout for sorting results according to one embodiment.

FIG. 6 is illustrates a component diagram of a computing device according to one embodiment.

Like reference numerals are used to designate like parts in the accompanying drawings.

### DETAILED DESCRIPTION

A more particular description of certain embodiments of Social Media Marketing Auction may be had by references to the embodiments shown in the drawings that form a part of this specification, in which like numerals represent like objects.

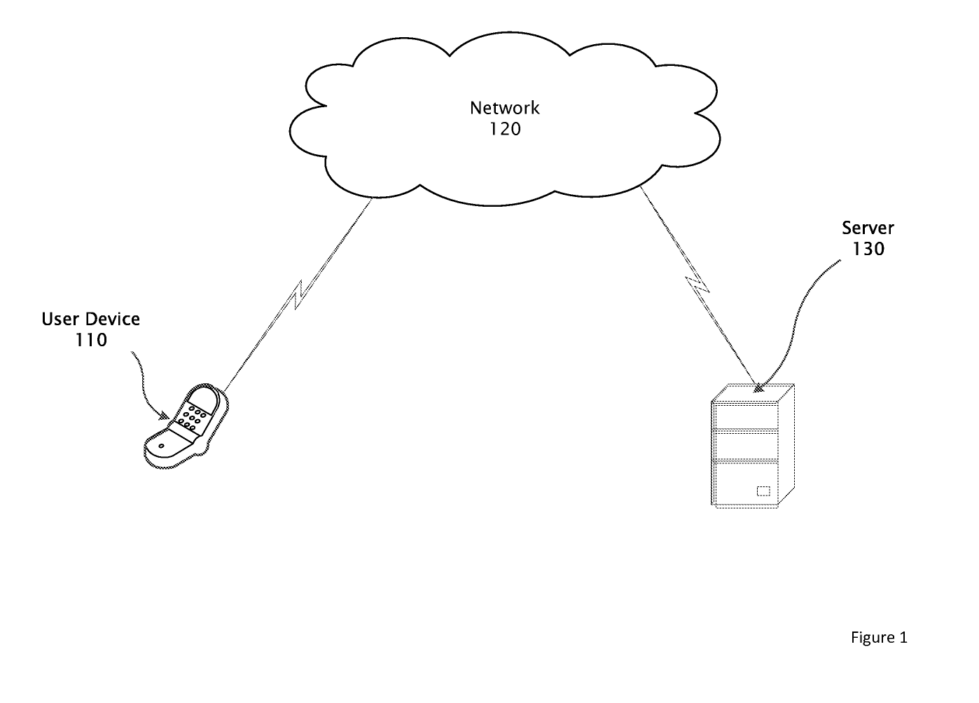

FIG. 1 illustrates a system capable of supporting Social Media Marketing Auction according to one embodiment. User Device 110 may include a processor, memory and computer readable storage media.

Network 120 may include Wi-Fi, cellular data access methods, such as 3G or 4GLTE, Bluetooth, NFC, the internet, local area networks, wide area networks, or any combination of these or other means of providing data transfer capabilities. In one embodiment, Network 120 may comprise Ethernet connectivity. In another embodiment, Network 120 may comprise fiber optic connections.

Server 130 may include one or more computers, and may serve a number of roles. Servers 130 may be conventionally constructed, or may be of a special purpose design for processing data for Social Media Marketing Auction. One skilled in the art will recognize that Server 130 may be of many different designs and may have different capabilities.

Server 130 may host applications, data, or other information supporting Social Media Marketing Auction. In one embodiment, for example, Server 130 may host a web site enabling a social media user to indicate an interest in promoting products or services. In another embodiment, Server 130 may host a web site enabling a user to bid on having a social media user promote products or services.

User Device 110 may be used to access information or programs on Server 130 related to Social Media Marketing Auction. Such information or programs may include auctions for a social media user to promote products or services, and ways to participate in the auctions.

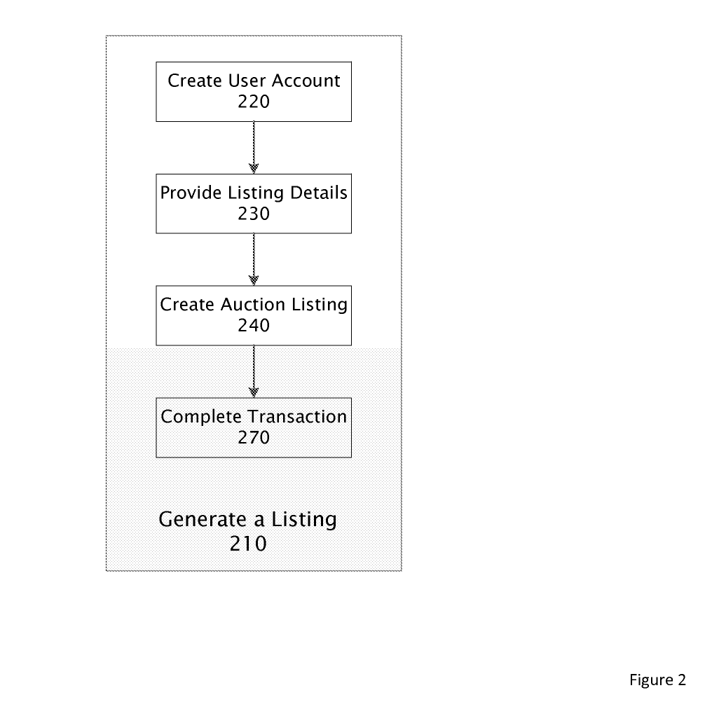

FIG. 2 is a flow diagram illustrating a Social Media Marketing Auction process to Generate a Listing 210 according to one embodiment. A seller, for example, a social media user, may begin the auction process at Create User Account 220, create a username, and provide contact and other information. User information may be stored in an electronic database. At Provide Listing Details 230, the seller's social media accounts may be manually or automatically linked to the auction site. Additional information, such as a time frame an auction will be open, minimum price (reserve), social networking sites to be used, or additional terms may be provided. By registering on the site, users may agree to share information about their social networks such as, but not limited to, the number of followers they have and their follower's interests. This information may also be automatically compiled by a software program.

At Create Auction Listing 240, a seller may put a marketing service up for sale. The service offered may consist of an endorsement, which may be any form of advertisement on a social media platform. For example, a reality television star may offer to promote a style of designer shoes to her social media followers in a tweet, status update, podcast, or other type of publication on any social networking platform such as Twitter, Facebook, or Instagram. The seller may start the auction bidding price at zero or any other amount; a reserve. The seller may also list a price at which any buyer may purchase the marketing service instantly, without having to compete with other bidders.

At Complete Transaction 270, a buyer and the seller may proceed to communicate with one another to complete the sale and provide feedback to each other. The seller who auctioned off the marketing service may receive payment in the amount offered by the bidder. The company the hosting the auction website may also profit from the transaction, for example, by charging the seller a percentage of the final sale price, by imposing service fees, or by other means.

In another embodiment, a seller may have a feed where potential buyers may send offers prior to an auction being created. A potential buyer may initiate the creation of an auction by sending a request for an endorsement to a social media user. Such an offer may include a price, the desired type of endorsement, and other information the buyer wishes to include. The social media user may then use that offer as a basis to create a listing for an auction as a seller. The seller may also set a price limit, such as a reserve, so that only offers above the price limit would enter the seller's feed.

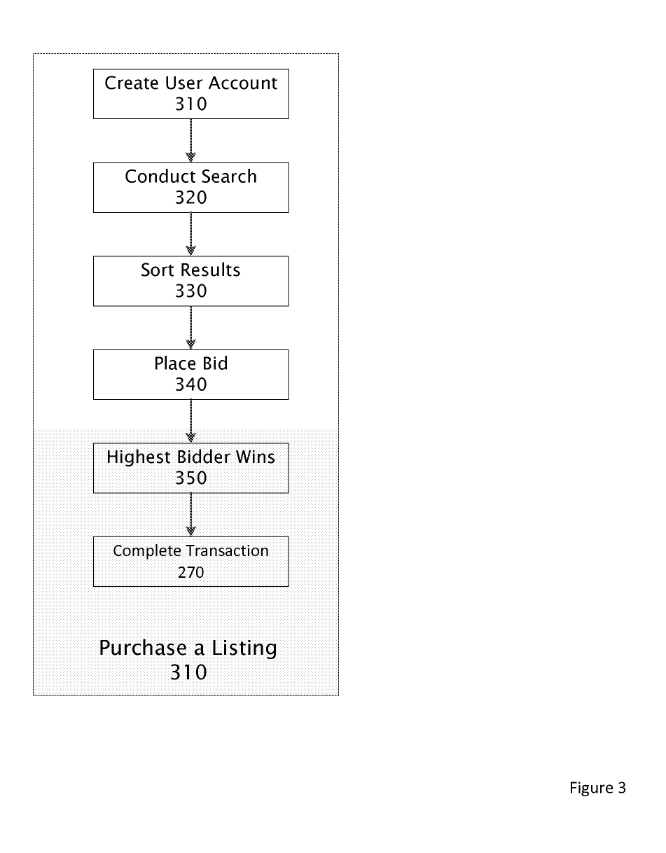

FIG. 3 is a flow diagram illustrating a Social Media Marketing Auction process to purchase a listing according to one embodiment. A potential buyer, for example an individual, organization, or business, may first Create User Account 310. The potential buyer may be required to create a username and to supply contact and credit card information. User information may be stored in an electronic database.

Users may create profiles which may display how much money they have transacted on the site or what types of products or services they are interested.

At Conduct Search 320, a user may search a database of information about other users, businesses and social networks, and may look for auctions of interest. At Sort Results 330, a user may manually prioritize the search results, or a software program may be configured to automatically sort the results based on predetermined preferences.

At Place Bids 340, potential buyers may place bids to buy a seller's offered marketing service. Multiple buyers may place different bids on one items, and a buyer may also set a maximum bid amount.

At Highest Bidder Wins 160, the bidder who offered to pay the highest amount by the time the auction ends may be entitled to purchase the item.

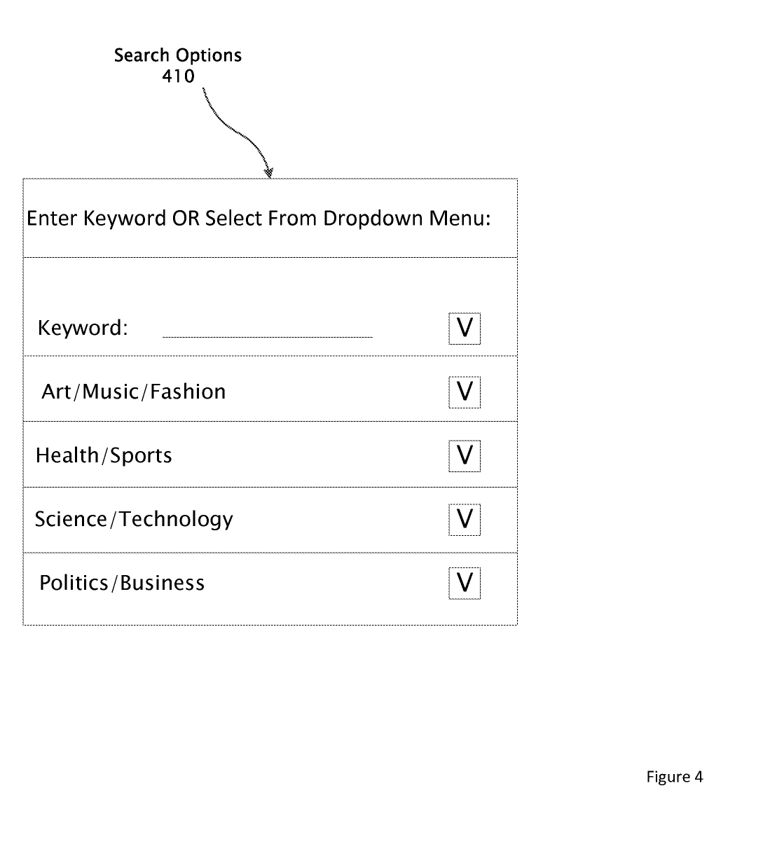

FIG. 4 is a user interface layout for conducting Search Options 410 according to one embodiment. At Conduct Search 320, a buyer may either enter a keyword, for example, “Shoes” or “Alternative Music” into a search bar or select a topic from a drop-down menu. Drop-down menu items may include, but are not limited to topics such as Art/Music/Fashion, Health/Sports, Science/Technology, and Politics/Business. A software program may search the database of user information to supply results tailored to the user's inputs.

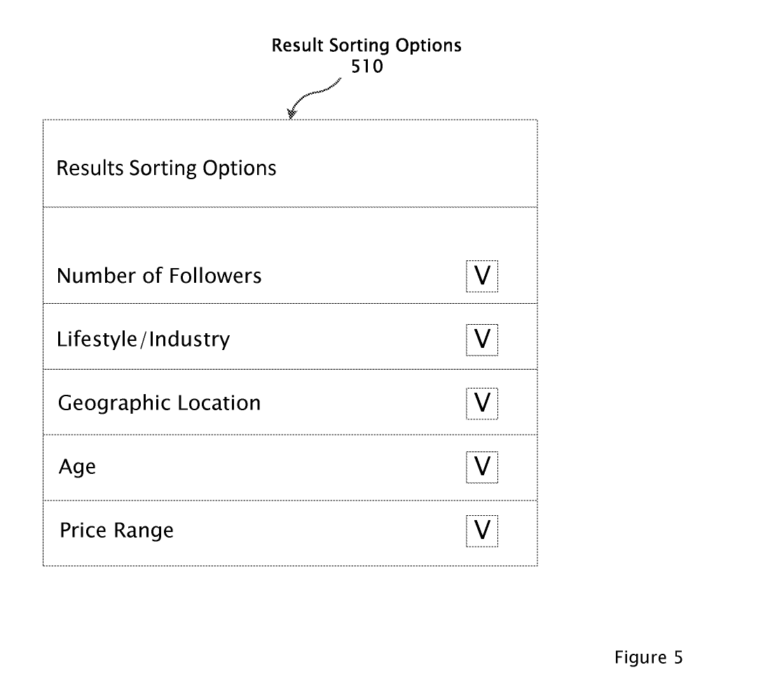

FIG. 5 is a user interface layout for Result Sorting Options 510 according to one embodiment. In this example, a user may manually Sort Results 330 by various factors such as Number of Followers, Lifestyle/Industry, Geographic Location, Age, or Price Range. A user may also save the user's preferences for default sorting.

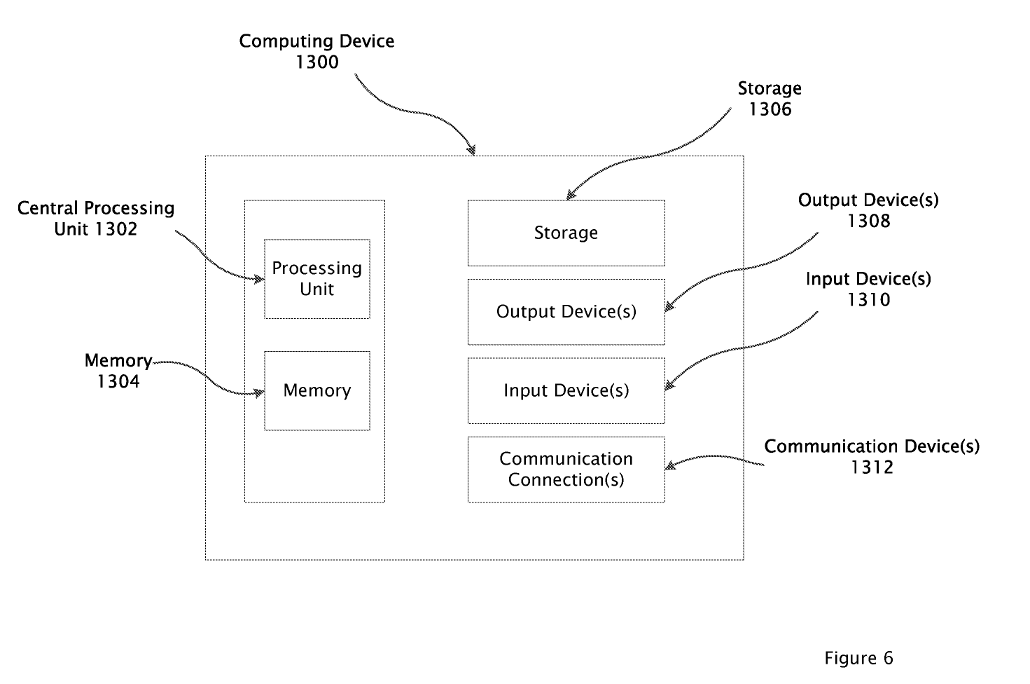

FIG. 6 is illustrates a component diagram of a computing device according to one embodiment. The Computing Device 1300 can be utilized to implement one or more computing devices, computer processes, or software modules described herein, including, for example, but not limited to a mobile device. In one example, the Computing Device 1300 can be used to process calculations, execute instructions, and receive and transmit digital signals. In another example, the Computing Device 1300 can be utilized to process calculations, execute instructions, receive and transmit digital signals, receive and transmit search queries and hypertext, and compile computer code suitable for a mobile device. The Computing Device 1300 can be any general or special purpose computer now known or to become known capable of performing the steps and/or performing the functions described herein, either in software, hardware, firmware, or a combination thereof.

In its most basic configuration, Computing Device 1300 typically includes at least one Central Processing Unit (CPU) 1302 and Memory 1304. Depending on the exact configuration and type of Computing Device 1300, Memory 1304 may be volatile (such as RAM), non-volatile (such as ROM, flash memory, etc.) or some combination of the two. Additionally, Computing Device 1300 may also have additional features/functionality. For example, Computing Device 1300 may include multiple CPU's. The described methods may be executed in any manner by any processing unit in computing device 1300. For example, the described process may be executed by both multiple CPU's in parallel.

Computing Device 1300 may also include additional storage (removable and/or non-removable) including, but not limited to, magnetic or optical disks or tape. Such additional storage is illustrated in FIG. 6 by Storage 1306. Computer readable storage media includes volatile and nonvolatile, removable and non-removable media implemented in any method or technology for storage of information such as computer readable instructions, data structures, program modules or other data. Memory 1304 and Storage 1308 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 1300. Any such computer readable storage media may be part of computing device 1300. Computer readable storage media does not include transient signals.

Computing Device 1300 may also contain Communications Device(s) 1312 that allow the device to communicate with other devices. Communications Device(s) 1312 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device 1300 may also have Input Device(s) 1310 such as keyboard, mouse, pen, voice input device, touch input device, etc. Output Device(s) 1308 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A social media marketing auction system, comprising:
a processor;
memory operatively coupled to the processor;
components operable on the processor, comprising:
a user registration component, configured to enable user registration;
an auction listing component, configured to accept an auction listing for a social media endorsement;
a user preference recording component, configured to record user preferences, the user preferences pertaining to auction listings of interest to the user;
a database searching component, configured to search a database of based on inputs from a user and return one or more auction listings;
a result sorting component, configured to sort the returned auction listings based on preferences of the user; and
a bidding component, configured to accept bids on at least one returned auction listing for the social media endorsement.

2. The social media marketing auction system of claim 1 wherein user registration may comprise linking from one or more social media accounts.

3. The social media marketing auction system of claim 1 further comprising wherein a software program is configured to automatically compile user data from external sources.

4. The social media marketing auction system of claim 1 wherein a software program is configured to automatically compile user follower data from external sources.

5. A method, comprising:
providing listing details for an auction for an endorsement, the listing details comprising:
a user identifier;
a social media site to host the endorsement;
a number of followers the user has on the social media site;
demographic information about the followers;
a starting bid price for the auction;
creating the auction; and
receiving bids for the endorsement.
